(19) United States
(12) Patent Application Publication
(10) Pub. No.: US 2014/0196800 A1
(43) Pub. Date: Jul. 17, 2014

(54) POST VALVE PROTECTIVE DEVICE

(71) Applicant: Progressive Plastics, Inc, Williamstown, VT (US)

(72) Inventor: Henry Buermann, Brookfield, VT (US)

(73) Assignee: Progressive Plastics, Inc, Williamstown, VT (US)

(21) Appl. No.: 14/153,698

(22) Filed: Jan. 13, 2014

Related U.S. Application Data
(60) Provisional application No. 61/751,718, filed on Jan. 11, 2013.

(51) Int. Cl. F16K 35/00

(52) U.S. Cl. CPC F16K 35/00
USPC 137/377; 29/428

(57) ABSTRACT

The presently-disclosed subject matter includes protective covers for post valves. The protective covers can comprise a tubular member, one or more shelves extending from the exterior surface of the tubular member, and one or more support members extending between the exterior surface of the tubular member and the one or more shelves.

### RELATED APPLICATIONS

This application claims priority from U.S. Provisional Patent Application No. 61/751,718, filed Jan. 11, 2013, the entire disclosure of which is incorporated herein by this reference.

### TECHNICAL FIELD

The presently-disclosed subject matter relates to a protective cover for compressed gas cylinders. In particular, embodiments of the presently-disclosed subject matter relate to a protective cover for use in connection with a post valve of a compressed gas cylinder. Embodiments of the presently-disclosed subject matter also relate to methods of utilizing and manufacturing a protective cover.

### BACKGROUND

Various industries and individuals rely on specialized gas provided from compressed gas cylinders. For example, in the medical field, oxygen can be provided from compressed gas cylinders to patients. Research facilities and various chemical plants also can obtain specific gases from compressed gas cylinders. Certain compressed gas cylinders have a design wherein a post valve couples to and extends from an end of the cylinder, the post valve being configured to receive a regulator, a hose, or the like in order to deliver the gas.

Post valves of compressed gas cylinders are subjected to various elements during transportation and use, including dirt, dust, water, and other contaminants. Accordingly, it is desirable to protect and cover a post valve, and particularly the gas outlet of a post valve, to ensure that the valve does not become clogged and gas can flow freely. It is also desirable for a post valve cover to indicate whether a compressed gas cylinder has been used after the cover is removed. Furthermore, post valve covers should be easy to install and remove from a compressed gas cylinder post valve.

Some have attempted to design covers for post valves that are intended to meet some of the above-identified needs. For example, U.S. Pat. No. 3,125,242 describes a sanitary sealing apparatus for ports of medical gas cylinders. This sealing apparatus comprises a band that is frictionally secured to the post valve and covers the gas outlet of the post valve. The sealing apparatus is installed by pushing the post valve through the opening of the band, which requires a certain amount of force. It can be difficult to provide the force to install the sealing apparatus because the thin band does not comprise a wide, rigid surface to push.

U.S. Pat. No. D612,012 describes a seal retainer comprising a seal retainer strap and flanges that extend perpendicularly with respect to a longitudinal length of the post valve. Some of the flanges are difficult to reach and push because they are located on the bottom end side of seal retainer strap. The flanges are made of the same flexible and thin material of the seal retainer strap and be difficult to push when installing the seal retainer strap on a post valve. U.S. Patent Publication No. 2011/0210134 discusses a different gas bottle valve stem protective sleeve that must cover substantially the entire post valve.

Accordingly, there remains a need for a protective cover for compressed gas cylinder post valves that is more comfortable and easy to push when installing the protective cover on a post valve. Thus, a protective cover that meets these needs is highly desirable and beneficial.

### BRIEF DESCRIPTION OF THE DRAWINGS

FIG. 1 is a perspective view of an embodiment of a protective cover in accordance with an embodiment of the presently-disclosed subject matter.

FIG. 2 is a side perspective view of the embodiment of the protective cover.

FIG. 3 is a rear perspective view of the embodiment of a protective cover.

FIG. 4 is a perspective view of another embodiment of a protective cover.

FIG. 5 is a front perspective view of another embodiment of a protective cover.

FIG. 6 is a rear perspective view of another embodiment of a protective cover.

FIG. 7 is a perspective view of another embodiment of a protective cover.

FIG. 8 is a cross-sectional view of a tubular member of another embodiment of a protective cover.

FIG. 9 is a cross-sectional view of a tubular member of another embodiment of a protective cover.

FIG. 10 is a cross-sectional view of a corner of a tubular member of another embodiment of a protective cover that is mounted on a post valve.

FIG. 11 is a front perspective view of a post valve having pin index holes and a gas outlet.

FIG. 12 is a rear perspective view of a post valve showing the burst disc.

### DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by one of ordinary skill in the art, definitions may be set forth to facilitate explanation of the presently-disclosed subject matter.

Following long-standing patent law convention, the terms “a”, “an”, and “the” refer to “one or more” when used in this application, including the claims. Thus, for example, reference to “an edge” includes a plurality of such edges, and so forth. Unless otherwise indicated, all numbers expressing quantities, measurements, and so forth used in the specification and claims are to be understood as being modified in all instances by the term “about”.

The presently-disclosed subject matter includes a protective cover for the post valves of compressed gas cylinders. In some embodiments the post valves are for compressed oxygen gas cylinders. The protective covers can be provided to, among other things, protect a post valve, and in some embodiments specifically protect the gas outlet of a post valve from dirt, debris, dust, water, chemicals, biological contaminants, and the like. Protective covers can help post valves maintain their ability to accurately, freely, and steadily provide gas from a compressed gas cylinder.

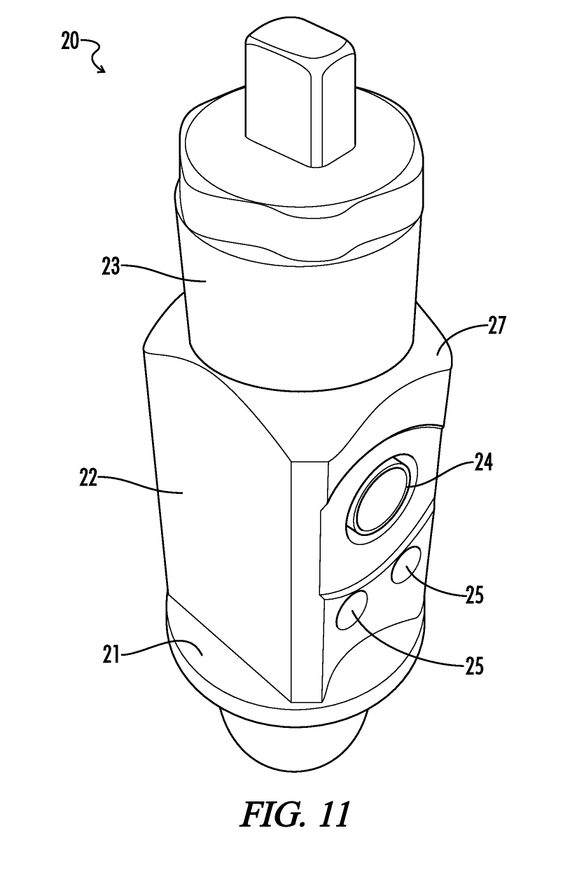

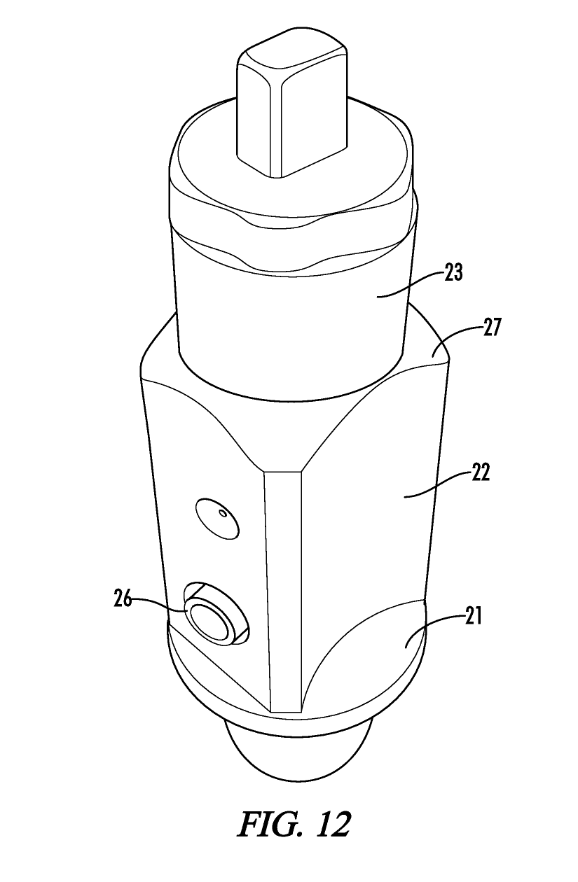

FIGS. 11 and 12 show an exemplary compressed oxygen cylinder post valve (CGA-870) that can be used in conjunction with the presently-disclosed protective covers. FIG. 11 shows a post valve 20 having a base 21, four faces 22, and a top portion 23. The base 21 of the post valve 20 is a circular object or disc that extents perpendicularly relative to a longitudinal direction of the post valve 20. The faces 22 are generally flat portions in the middle of the length of the post valve 20. When viewed from a cross-section, the flat portions of the four faces 22 form a square with chamfered edges. The top portion 23 of the post valve 20 has a circular cross section and has a surface that is parallel to a longitudinal direction of the post valve 20.

Furthermore, the faces 22 of the post valve 20 include a top portion of the faces 27. The top portion of the faces 27 is adjacent to a top portion 23 of the post valve 20. The top portion of the faces 27 can have a surface that is angled relative to a longitudinal direction of the post valve 20. The top portion of the faces 27 can also include a lower end side (i.e., lower end of top portion of faces 27) that is arched.

As shown in FIG. 11, the post valve 20 also comprises a gas outlet 24 and pin index holes 25 located on one of the faces 22. The arrangement of the pin index holes 25 on the face 22 of the post valve 20 can be used to identify the type of gas in a cylinder. Specifically, a post valve 20 having pin index holes 25 generally can only couple to certain regulators having pins that correspond to the pin index holes 25. FIG. 12 shows another view of the post valve 20, and shows a face 22 having a burst disc 26 that is opposite the face 22 having the gas outlet 24 and the pin index holes 25.

In this regard, when referring to the post valve of the presently-disclosed subject matter, the bottom end side corresponds to a side of the post valve that can couple to a compressed gas cylinder, and the top end side refers to a side opposite the compressed gas cylinder when the post valve is installed. Furthermore, a longitudinal direction of the post valve, or a protective cover mounted thereon, extends between the top end side and the bottom end side of the post valve.

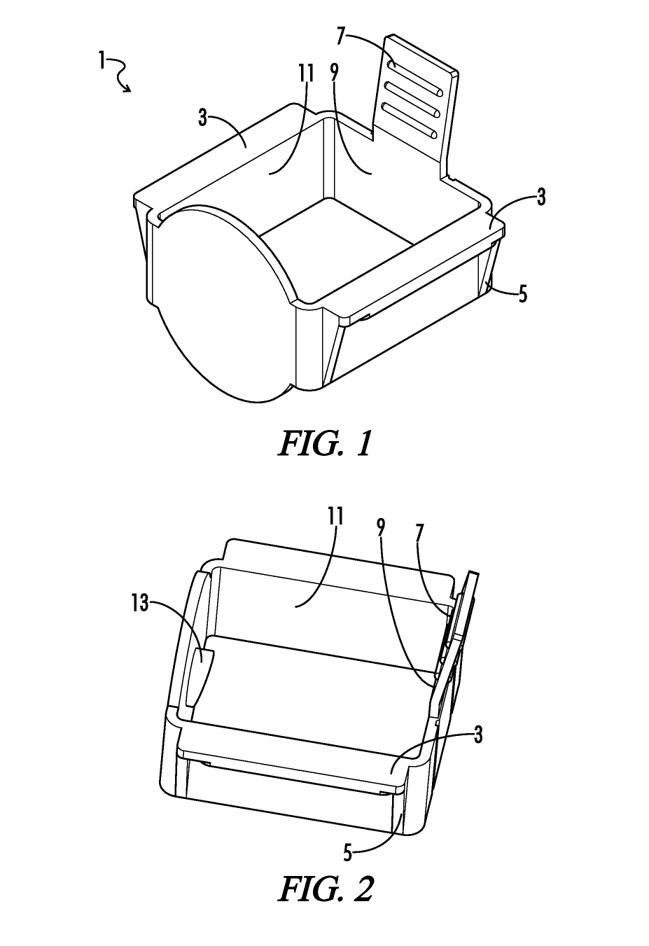

Referring now to FIGS. 1-3, an embodiment of the presently-disclosed subject matter is shown from various views. FIG. 1 shows an embodiment of a protective cover 1 that comprises a tubular member 11. The tubular member 11 is dimensioned so as to have an opening that is sufficiently large to receive a post valve 20. However, in some embodiments the protective cover 1 can be partially or completely made of a material that is elastic. In such embodiments, the tubular member 11 can have an opening that is dimensioned smaller than a cross-section of the post valve 20, and the elastic tubular member 11 can stretch when installing the protective cover 1 on the post valve 20. On the other hand, in some embodiments the tubular member 11 can be made of a material that is non-elastic and does not stretch, and therefore the opening of the tubular member 11 is at least as large as a cross-section of the post valve 20.

The embodied tubular member 11 has a substantially uniform thickness in the circumferential direction. The tubular member 11 is four-sided, although a tubular member 11 can have any number of sides. In some embodiments the tubular member has any number of sides so as to correspond to the shape of a particular post valve, and may have as many sides as there are faces on a post valve. The tubular member 11 comprises a top end side, a bottom end side, and an exterior surface. When a protective cover 1 is installed on a post valve 20, the exterior surface of the tubular member 11 can remain exposed. Also, the top end side and the bottom end side of the tubular member 11 correspond to end sides that are closest to, respectively, the top end side and the bottom end side of the post valve 20 when the protective cover 1 is installed on the post valve 20.

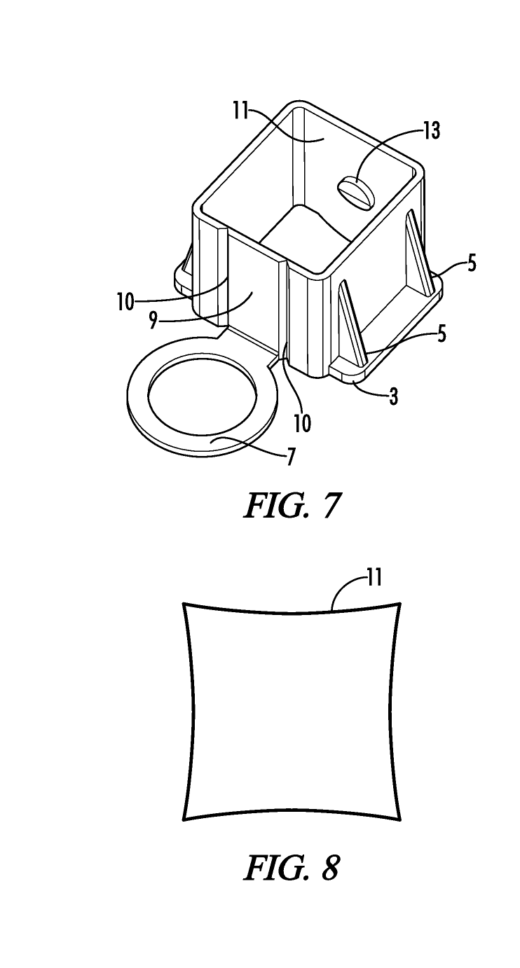

The embodiment comprises one or more shelves 3 that extend from the exterior surface at the top end side of the tubular member 11. In other embodiments the shelves 3 can be provided at any location on the exterior surface of the tubular member 11. In particular embodiments the shelves 3 can be provided at a bottom end side of the tubular member 11 (see, e.g., FIG. 7). The shelves 3 can extend at any angle relative to the longitudinal direction of the tubular member 11, and can extend at a 90 degree angle relative to the longitudinal direction of the tubular member 11 and/or the exterior surface of the tubular member 11. The shelves 3 can provide a surface on which a force can be applied when installing the protective cover 1 on a post valve 20. For protective covers 1 made via injection molding or the like, the shelves 3 can provide a surface for ejector pins to push on to can eject the protective cover 1 from a mold.

Some embodiments comprise two distinct shelves 3, and in such embodiments an even force can be applied to opposing sides of a protective cover 1 by applying a force to each of the two distinct shelves 3. Furthermore, some embodiments comprise three or more shelves 3. In some embodiments the shelves are continuous, meaning that the shelf 3 extends uninterrupted along a length. Shelve(s) 3, including some continuous shelves 3, can extend the length of two or more sides of a tubular member 11. In some embodiments the shelves 3 are not continuous, but instead are distinct shelves 3 that are not connected to one another. In some embodiments two or more distinct shelves 3 can be provided on a single side of the tubular member 11.

Still looking to FIG. 1, two support members 5 are provided for each shelf 3. The support members 5 extend between the exterior surface of the tubular member 11 and a bottom end side of the shelf 3. For example, a shelf may be provided on a top end side of the tubular member and extend toward and/or to the bottom end side of the tubular member (see, e.g., FIG. 1). As another example, a shelf may be provided on a bottom end side of the tubular member and extend toward and/or to the top end side of the tubular member (see, e.g., FIG. 7). The support members 5 can structurally support the corresponding shelf 3 at least when a force is applied from the top end side and/or bottom end side of the shelves 3.

As shown in FIG. 1, the support members 5 can be a triangular or radial when viewed from the side, wherein one side of the support member 5 is provided along one side (e.g., the bottom end side) of the shelf 3 and another side spans between the top end side and the bottom end side of the exterior surface of the tubular member 11. Furthermore, the support member 5 shown in FIG. 1 has a thickness that is about the same as the thickness of the tubular member.

Embodiments can comprise support members 5 of any width. Similarly, those of ordinary skill in the art will appreciate that the shape and dimension of the support members 5 can be modified so long as they lessen the extent to which the shelve(s) 3 and/or support members 5 flex when a force is applied thereto. Accordingly, the support member 5 can be a truss that extends between the tubular member 11 and a shelf 3, a bar that extends between the tubular member 11 and a shelf 3, or the like. In some embodiments the support member 5 extends across the entire length of a shelf 3. In some embodiments comprising a support member 5 that extends across the entire length of a shelf 3, the support member 5 and shelf 3 can collectively form an elongated object having a substantially triangular cross-sectional shape.

The embodiment shown also comprises a tear strip 9 connected to a pull tab 7. In some embodiments the tear strip 9 is a portion of the tubular member 11 that can be removed so as to form a break in the tubular member 11. When the tear strip 9 is removed, the protective cover 1 can be removed from a post valve 20. The pull tab can be an extension 7 of the tear strip 9, and can be pulled by a user to separate the tear strip 9 from the tubular member 11.

Referring now to FIG. 2, there is a shown a different view of the tubular member 11. A protrusion 13 is provided on the interior surface of tubular member 11 that extends into the opening of the tubular member 11. The protrusion 13 is configured to engage a gas outlet 24 on a post valve 20. The protrusion 13 has a generally cylindrical shape and a diameter that is equal to or less than that of the gas outlet 24 of the post valve 20. Also, the bottom end side of the protrusion 13 can be shorter in length than the top end side of the protrusion 13 so that all or part of a distal end of the protrusion 13 is angled relative to the longitudinal length of the protective cover 1. In some instances when installing a protective cover 1, a protrusions 13 with an angled distal end may pass across the post valve 20 with relative ease, thereby facilitating installation. Furthermore, while the cross-sectional shape of the protrusion 13 is roughly circular, the protrusion 13 can be of any shape and size, including shapes that correspond to the particular orifice a protrusion 10 is configured to engage. For instance, some protrusions 10 are configured to engage, and can have a shape that corresponds to, pin index holes 25 and/or burst discs 26 located on a face 22 of a post valve 20.

FIG. 2 shows the tear strip 9 and the pull tab 7, and illustrates that the pull tab 7 can be angled relative to the longitudinal direction of the tubular member 11. In such embodiments the pull tab 7 will be angled relative to the post valve 20 when the protective cover 1 is installed on a post valve 20. The pull tab 7 can be at any angle relative to the tear strip 9 and tubular member 11. For example, the pull tab 7 can be angled by 15, 30, 45, 60, or 75 degrees relative to the tubular member 11. In some embodiments the pull tab 7 is extends perpendicularly relative to a longitudinal direction of the protective cover 1, and therefore it extends perpendicularly from a post valve 20 when the protective cover 1 is installed (see, e.g., FIG. 7). In other embodiments the pull tab 7 can be provided at any location that allows the pull tab 7 to remove the tear strip 9. In some instances the pull tab 7 can be at the top end side of a tear strip 9, a bottom end side of a tear strip 9, or at any location therebetween.

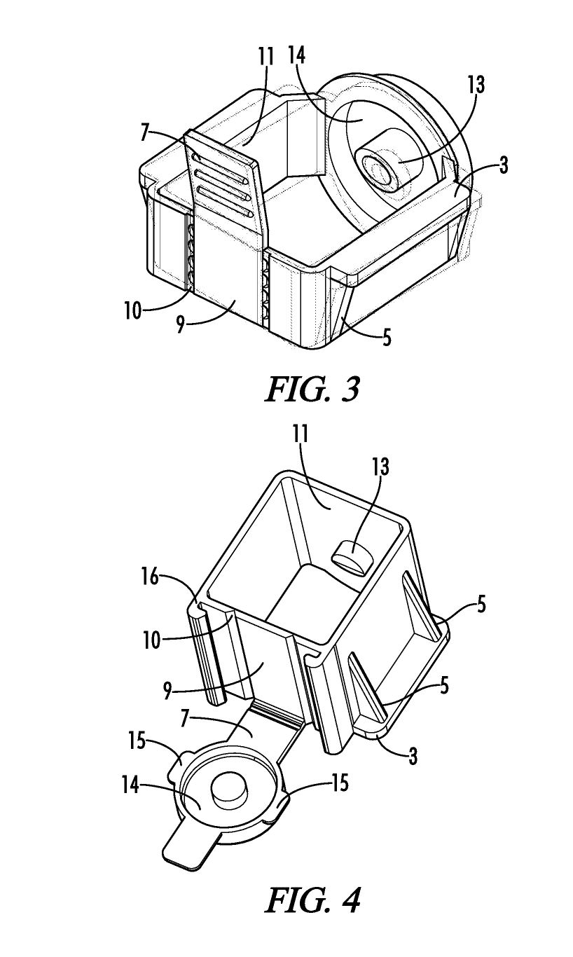

Referring now to FIG. 3, there is shown an embodiment of the protective cover 1 that includes tear lines 10 on both sides of the tear strip 9. In such embodiments, a user can uninstall a protective cover 1 from a post valve 20 by pulling a pull tab 7 so that tear lines 10 separate and release the tear strip 9 from the tubular member 11. Some embodiments of protective covers 1 will comprise only one tear line 10, and the pull tab 7 can be provided on or near the single tear line 10. The tear line 10 can be any structure that is structurally weaker than the tubular member 11. For example, the tear line 10 may comprise a row of indentations, perforations, or holes on the tubular member 11. In some embodiments the tear line 10 is a V-shaped or U-shaped groove in the tubular member 11, wherein the center of the tear line 10 can correspond to a portion of the tubular member 11 having the smallest thickness and that can thus be separated with relative ease.

FIG. 3 an embodiment including a protective cover 1 that includes a washer housing 14. The washer housing 14 can contain a washer to be used when coupling a regulator to the post valve 20. As shown in FIG. 3, the washer housing is a cavity that is integral with the tubular member 11 and that surrounds the protrusion 13. The washer housing 14 can retain a washer so long as the protective cover 1 is installed on a post valve 20. When the protective cover 1 is removed from a post valve 20, the cavity that forms the washer housing 14 is exposed so that the washer can be removed. Other embodiments comprise washer housings 14 that are located on different parts of the protective cover 1.

For instance, the washer housing 14 may be located on any portion of the tubular member 10 or on the pull tab 7. To illustrate an exemplary protective cover 1, FIG. 4 shows a protective cover 1 having a washer housing 14 that is located on and is integral with the pull tab 7. The embodiment shown in FIG. 4 further comprises a pair a grooves 16 located on opposite sides of one side of the tubular member 11, and extend in a longitudinal direction of the tubular member 11 from its top end side to its bottom end side. The protective cover 1 in FIG. 4 also includes a pair of lugs 15 located on opposite sides of the washer housing 14. To house a washer, one can place a washer in the washer housing 14, and subsequently bend the pull tab 7 until the pair of lugs 15 engage the respective grooves 16. In this manner, the washer is contained in the washing housing 14 by the exterior surface of the tubular member 11.

Some embodiments may or may not require that the protective cover 1 be installed to remove and use the washer. In some embodiments the washer housing 14 is enclosed and retained in the washer housing 14 by a cover, strap, or the like.

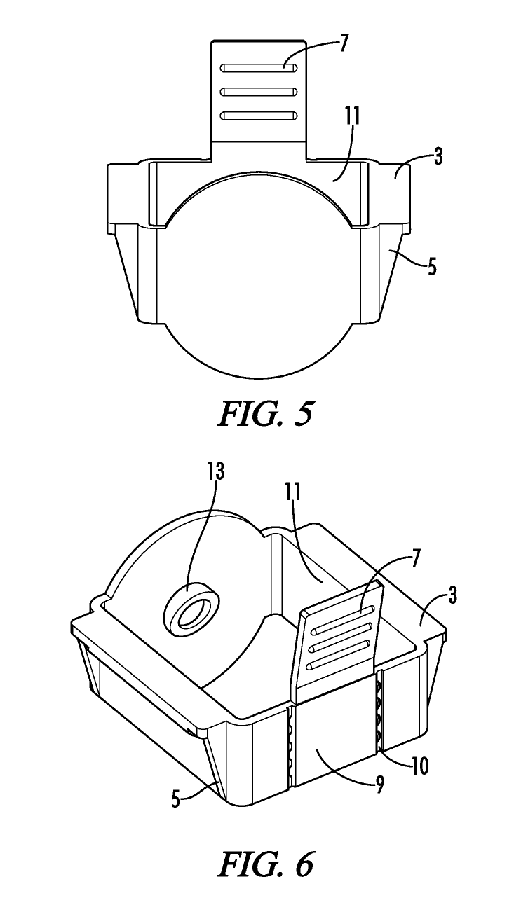

FIG. 5 shows yet another view of an embodiment of a protective cover 1. FIG. 5 shows that the support member 5 can form a right triangle, where the right corner of the support member 5 is located at the junction between the shelf 3 and the tubular member 11. In some embodiments the support member 5 does not comprise a continuous surface, but instead can comprise holes or can be a bar that extends from the shelf 3 to the tubular member 11. The support member 5 shown in FIG. 5 comprises an outward edge that is straight, but in other embodiments the outwardly facing edge can be curved, arched, or the like. While the shape and dimension of the support member 5 are not particularly limited, the support member 5 can provide mechanical support when a force is applied to the shelf 3.

In some embodiments, support members 5 have the surprising and unexpected advantage of increasing the rigidity of the tubular member 11 and/or protective cover 1 as a whole, which can facilitate installation or removal of the protective cover from a post valve. For example, by virtue of the support members 5 supporting the shelves 3, the vertical rigidity of the shelves 3 and/or tubular member 11 can increase so that more force can be applied to the shelves 3 when installing a protective cover 1. Additionally or alternatively, in some embodiments the support members 3 enhance the lateral rigidity of the tubular member 11. Thus, when installing the protective cover 1, the problem of having the sides of the tubular member 11 cave inwardly can be reduced or eliminated.

Referring to FIG. 6, another embodiment of the presently-disclosed subject matter is shown. The embodied protective cover does not comprise a washer housing. The protrusion 13 is provided on a portion of the tubular member 11 that has a flat surface.

The above described protective covers 1 are only intended to illustrate some embodiments that are in accordance with the presently-disclosed subject matter and that can be modified without departing from the scope of this subject matter. For example, embodiments of protective covers 1 can have different heights, the height corresponding to the length between the bottom end side to the top end side of the tubular member 11. In some embodiments protective covers 1 have a height such that the protective cover 1 extends from the base 21 of a post valve to the top end side of the post valve 20. In some embodiments the protective cover 1 extends from the base 21 of the post valve to any point on the faces 22, including a location on the top portion of the faces 27, or a location on the top portion of the post valve 23. In still further embodiments, the protective cover 1 extends along only a portion of the faces 22 of the post valve.

Furthermore, the interior of the protective cover can be dimensioned so as to correspond to and couple the post valve. In some embodiments the interior opening of the protective cover is smaller than the post valve so that the protective cover must stretch and expand to accommodate the post valve, and this ability to stretch can depend on the material used for the protective cover. Accordingly, embodiments of protective covers can be made of any material, including a material that comprises plastic, polymers, rubber, metal, or combinations thereof.

Furthermore still, in other embodiments the protective cover 1 is made so that the tubular member 11 may stretch, expand, and/or deform to accommodate a post valve 20. As discussed above, in some embodiments the tubular member 11 comprises an elastic material that can stretch to accommodate a poste valve 20. In other embodiments the tubular member 11 has one or more corners that form an angle equal to or less than 90 degrees. For example, the corner(s) of the tubular member can be about 50 degrees, about 60 degrees, about 70 degrees, about 80 degrees, or about 90 degrees. The corner(s) in some embodiments can also be less than about 50 degrees. Accordingly, when a post valve 20 is inserted into the opening of the tubular member 11, the angle of the corner(s) will create a gap between the post valve 20 and the corner(s) of the tubular member 11, and this gap will allow the protective cover 1 to deform to allow a larger internal dimension upon installation, if necessary. FIG. 8 shows a cross-sectional diagram of an embodiment of a protective member 1 that has a tubular member 11 with corners that are less than 90 degrees.

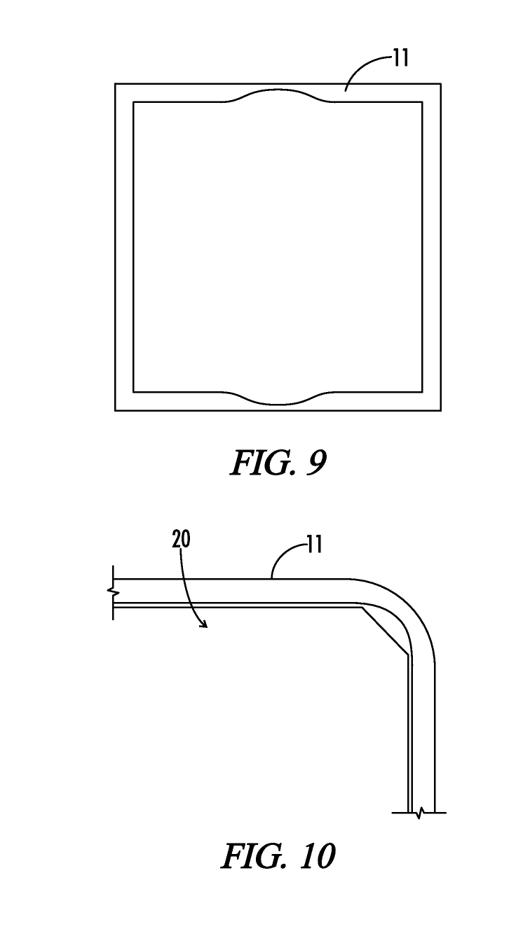

Other embodiments have a tubular member 11 that, by virtue of having relatively thick sections and relatively thin sections, can stretch to accommodate a post valve 20. For example, FIG. 9 shows a cross-sectional diagram of an embodiment of a tubular member 11, wherein two sides of the tubular member 11 include a relatively thin middle section. In such embodiments, the relatively thin sections of the tubular member 11 can stretch, if necessary, to accommodate a post valve 20. Of course, other embodiments may have any number of sides that comprise any number of relatively thin sections that can stretch to accommodate a post valve 20.

Some embodiments of protective covers 1 comprise tubular members 11 that include corners having a radius on the interior surface that is smaller than a radius of the exterior surface of the tubular member 11 (FIG. 10). By virtue of having corners that include an internal radius that is smaller than the external radius, the corners of the tubular member 11 are relatively thin compared to other sections of the tubular member 11. As shown on FIG. 10, when the protective cover 1 is installed on a post valve 20, the corners of the tubular member 11 can stretch and/or bend to accommodate the post valve 20.

While additional specific embodiments have been described, those of ordinary skill in the art will appreciate that other embodiments of tubular members 11 that do not depart from the scope of this disclosure and the subject matter disclosed herein.

The presently-disclosed subject matter further relates to methods for utilizing a protective cover. In some embodiments a method is provided that comprises providing a protective cover that includes a tubular member, the tubular member including an interior opening for receiving the post valve, an exterior surface, a top end side, and a bottom end side, one or more shelves extending from the exterior surface of the tubular member, and one or more support members extending between the exterior surface of the tubular member and the one or more shelves, the support members being configured to support the one or more shelves when a force is applied thereto. The method further comprises inserting the post valve through the interior opening of the tubular member from the bottom end side of the tubular member. In some embodiments the step of inserting the post valve comprises engaging an orifice on the post valve with a protrusion extending in the interior direction of the tubular member. The orifice can be a gas outlet, one or more pin index holes, any other hole provided on the post valve, or combinations thereof. Thus, in some embodiments the orifice is a hole.

The presently-disclosed subject matter still further relates to methods for manufacturing a protective cover. In some embodiments the protective cover can be made via injection molding.

In some instances the present protective covers are easier and/or less expensive to manufacture via injection molding when compared to known covers. After an item has been formed via injection molding it is pushed out of the mold with ejectors. For known covers without shelves, blade-shaped ejectors are used that match the edge of the tubular member. An exemplary mold can include as many as 8 or more blade-shaped ejectors. However, the blade-shaped ejectors are fragile because they are only as thick as the tubular member. The blade-shaped ejectors can also damage the edge of a protective cover when pushing it out of a mold. Known protective covers that have a flanges are also ejected from molds with blade-shaped ejectors because the unsupported flanges flex and bend when a force is applied thereto. Therefore, the ejectors must push on and correspond in thickness to the tubular member.

On the other hand, the present protective covers have shelves with support members. The shelves that include support members are relatively stronger, and can be used to eject a protective cover from a mold. In some instances standard ejector pins can push a shelf, optionally at or near the location of a support member. Ejector pins are generally less expensive to purchase and operate than blade-shaped ejectors. Thus, the present protective covers can be more efficient and less expensive to manufacture with injection molding.

It will be understood that various details of the presently disclosed subject matter can be changed without departing from the scope of the subject matter disclosed herein. Furthermore, the foregoing description is for the purpose of illustration only, and not for the purpose of limitation.

What is claimed is:

1. A protective cover for a post valve, comprising:
a tubular member including an interior opening for receiving the post valve, an exterior surface, a top end side, and a bottom end side;
one or more shelves extending from the exterior surface of the tubular member; and
one or more support members extending between the exterior surface of the tubular member and the one or more shelves, the support members being configured to support the one or more shelves when a force is applied thereto.

2. The protective cover of claim 1, wherein the one or more shelves extend from the top end side of the tubular member and/or the bottom end side of the tubular member.

3. The protective cover of claim 2, wherein each of the support members extend from the top end side of the tubular member to the bottom end side of the tubular member and/or from the bottom end side of the tubular member to the top end of the tubular member.

4. The protective cover of claim 1, further comprising:
one or more tear strips extending from the top end side of the tubular member to the bottom end side of the tubular member.

5. The protective cover of claim 4, further comprising a pull tab connected to the tear strip.

6. The protective cover of claim 5, wherein the pull tab is parallel to a longitudinal axis of the protective cover.

7. The protective cover of claim 5, wherein the pull tab is angled relative to a longitudinal axis of the protective cover.

8. The protective cover of claim 7, wherein the pull tab is angled by about 0 to about 90 relative to the longitudinal axis of the protective cover.

9. The protective cover of claim 1, wherein each shelf includes to two or more of the support members.

10. The protective cover of claim 1, wherein each shelf includes one of the support members at each of its ends.

11. The protective cover of claim 1, further comprising a protrusion extending from the interior opening of the tubular member, the protrusion configured to engage an orifice on the post valve.

12. The protective cover of claim 1, wherein the orifice is a pin index hole and/or a gas outlet.

13. The protective cover of claim 1, further comprising a washer housing that can contain a washer when the protective cover is installed on a post valve.

14. The protective cover of claim 13, wherein the washer housing is a cavity that is integral with the tubular member, and the washer housing surrounds the protrusion on the tubular member.

15. The protection cover of claim 13, wherein the washer housing is integral with the pull tab.

16. The protective cover of claim 1, wherein the protective cover is made of a material chosen from a plastic, a polymer, rubber, or combinations thereof.

17. A protective cover, comprising:
a tubular member including an interior opening for receiving the post valve, an exterior surface, a top end side, and a bottom end side;
one or more shelves extending from top end side of the tubular member; and
a pair of support members extending between a bottom surface of each of the shelves and the exterior surface of the tubular member, the support members being configured to support the one or more shelves at least when a downward force is applied thereto.

18. A method for installing a protective cover on a post valve, comprising:
providing the protective cover that includes:
a tubular member including an interior opening for receiving the post valve, an exterior surface, a top end side, and a bottom end side;
one or more shelves extending from the exterior surface of the tubular member; and
one or more support members extending between the exterior surface of the tubular member and the one or more shelves, the support members being configured to support the one or more shelves when a force is applied thereto; and
inserting the post valve through the interior opening of the tubular member from the bottom end side of the tubular member.

19. The method of claim 18, wherein the step of inserting the post valve comprises engaging an orifice on the post valve with a protrusion that extends from an interior side of the tubular member.

20. The method of claim 19, wherein the orifice is a gas outlet, one or more pin index holes, or combinations thereof.
